(19) United States
(12) Patent Application Publication
(10) Pub. No.: US 2023/0117218 A1
(43) Pub. Date: Apr. 20, 2023

(54) CLOUD-EDGE FORWARDING IN A NETWORK

(71) Applicant: Marvell Israel (M.I.S.L) Ltd., Yokneam (IL)

(72) Inventors: Gideon NAVON, Tel-Aviv (IL); Zvi SHMILOVICI LEIB, Tel Aviv (IL); David MELMAN, Tel Aviv (IL)

(21) Appl. No.: 17/900,787

(22) Filed: Aug. 31, 2022

Related U.S. Application Data
(60) Provisional application No. 63/239,307, filed on Aug. 31, 2021.

(51) Int. Cl. H04L 45/745; H04L 45/00; H04L 12/46

(52) U.S. Cl. CPC H04L 45/745; H04L 45/566; H04L 12/4641

(57) ABSTRACT

A packet is received via a first network interface of a first network device in an underlay network, the packet having been originated by a first endpoint device and including a first network address indicating a destination of the first packet. The first network device, without analyzing the first network address in the first packet, adds, to the first packet, a second network address corresponding to a cloud edge network device implemented at the cloud edge and information identifying the first network interface via which the first packet was received by the first network device. The first network device transmits the packet, via an overlay network layered over the underlay network, to the cloud edge network device to enable forwarding of the packet to the destination of the packet, based on the first network address included in the packet, by the cloud edge network device

### CROSS REFERENCES TO RELATED APPLICATIONS

This application claims the benefit of U.S. Provisional Patent Application No. 63/239,307, entitled “Cloud-Edge Friendly Network,” filed on Aug. 31, 2021, the disclosure of which is hereby expressly incorporated herein by reference in its entirety.

### FIELD OF TECHNOLOGY

The present disclosure relates generally to communication networks, and more particularly to forwarding of packets in communication networks.

### BACKGROUND

Communication networks typically include a plurality of network devices, such as bridges, switches, routers, etc., that perform networking operations, such as forwarding of packets based on network addresses included in the packets. For example, a typical enterprise network includes a plurality of access network devices, such as access switches, that connect endpoint devices, such as computers, printers, cameras, monitors, etc., in the enterprise to each other as well as to external locations, such as private and/or public cloud devices or other devices accessible to the enterprise via external communication networks (e.g., carrier communication networks). Network devices in typical enterprise networks forward (e.g., bridge, switch and/or route) packets from the endpoint devices to destination of the packets based on network address included in the packets. Typically, such network devices maintain relatively complex forwarding and/or routing tables and perform complex lookups based on network addresses in packets to properly direct the packets to their destinations. Moreover, such network devices perform other networking functions, such as assigning packets to virtual ports or networks, e.g., virtual local area networks (VLANs), used for processing and forwarding the packets, applying access control lists (ACLs) to ensure that only approved users have access to various resources on the network, etc. Thus, these network devices are often complex, costly, difficult to maintain and have different vendor-specific requirements and configurations, requiring expensive and well-trained information technology (IT) personnel for configuring and maintaining the enterprise network.

### SUMMARY

In an embodiment, a method for transmitting packets in an underlay network that connects a plurality of endpoint devices to a cloud edge includes: receiving a first packet via a first network interface of a first network device in the underlay network, the packet i) having been originated by a first endpoint device among the plurality of endpoint devices and ii) including a first network address indicating a destination of the first packet; processing the first packet at the first network device, the processing including, without analyzing the first network address in the first packet, adding, to the first packet, i) a second network address corresponding to a cloud edge network device implemented at the cloud edge and ii) information identifying the first network interface via which the first packet was received by the first network device; and transmitting, by the first network device via an overlay network layered over the underlay network, the first packet to the cloud edge network device in the cloud edge to enable forwarding of the first packet to the destination of the packet, based on the first network address included in the first packet, by the cloud edge network device.

In another embodiment, a first network device in an underlay network that connects a plurality of endpoint devices to a cloud edge, comprises a plurality of network interfaces, and a packet processor coupled to the plurality of network interfaces. The packet processor configured to: receive a first packet via a first network interface among the plurality of network interfaces, the packet i) having been originated by a first endpoint device among the plurality of endpoint devices and ii) including a first network address indicating a destination of the first packet, process the packet at the first network device, the processing including, without analyzing the first network address in the first packet, adding, to the first packet, i) a second network address corresponding to a cloud edge implemented at the cloud edge and ii) information identifying the first network interface via which the first packet was received by the first network device, cause the packet to be transmitted via an overlay network layered over the underlay network, the first packet to the cloud edge network device in the cloud edge to enable forwarding of the first packet to the destination of the packet, based on the first network address included in the first packet, by the cloud edge network device.

In still another embodiment, a method for processing packets at a cloud edge connected to a plurality of endpoint devices by an underlay network includes: receiving a first packet at a cloud edge network device located at the cloud edge, the first packet i) having been originated by a first endpoint device among the plurality of endpoint devices, ii) having been transmitted, via an overlay network layered over the underlay network, by a first network device in the underlay network and iii) including a) a first network address indicating a destination of the first packet b) a second network address corresponding to the cloud edge network device at the cloud edge and c) information identifying a first network interface, of the first network device in the underlay network, that is coupled to the first endpoint device; determining, by the cloud edge network device based on the first network address included in the first packet, a second network interface of the cloud edge network device via which to transmit the first packet towards the destination of the first packet; and transmitting, by the cloud edge network device, the first packet via the second network interface of the cloud edge network device towards the destination of the first packet.

In yet another embodiment, a cloud edge network device located at a cloud edge connected to a plurality of endpoint devices to by an underlay network comprises: a plurality of network interfaces, and a packet processor coupled to the plurality of network interfaces, the packet processor configured to: receive a first packet received by the first network device via a first network interfaces among the plurality of network interfaces, the first packet i) having been originated by a first endpoint device among the plurality of endpoint devices, ii) having been transmitted, via an overlay network layered over the underlay network, by a first network device in the underlay network and iii) including a) a first network address indicating a destination of the first packet b) a second network address corresponding to the cloud edge network device at the cloud edge and c) information identifying a first network interface, of the first network device in the underlay network, that is coupled to the first endpoint device, determine, based on the first network address included in the first packet, a second network interface, among the plurality of network interfaces, via which to transmit the first packet towards the destination of the first packet, and cause the first packet to be transmitted via the second network interface towards the destination of the first packet.

### BRIEF DESCRIPTION OF THE DRAWINGS

FIG. 1 is a simplified diagram of an example communication system in which packets are transmitted via an overlay network between a cloud edge and endpoint device, and forwarding of the packets to packet destinations is performed at the cloud edge, according to an embodiment.

FIG. 2 is an example encapsulated packet transmitted in the overlay network of FIG. 1, according to an embodiment.

FIG. 3 is a flow diagram of an example method for transmitting packets in an underlay network that connects a plurality of endpoint devices to a cloud edge, according to an embodiment.

FIG. 4 is a flow diagram of an example method for processing packets at a cloud edge connected to a plurality of endpoint devices by an underlay network, according to an embodiment.

### DETAILED DESCRIPTION

In embodiments described below, various user-aware networking functions are moved from network devices in a communication network, such as an enterprise network, to a central location such as a cloud edge (e.g., a cloud edge data center) external to the enterprise network. For example, switching and/or routing functions, such as determining endpoint destinations of packets based on network addresses included in the packets and forwarding of the packets to the endpoint destinations of the packets, functions of learning endpoint destinations addresses (such as media access controller (MAC) addresses) based on packets, maintaining routing tables and performing routing of packets, etc. are moved from networking devices in the communication network to the cloud edge external to the network. In some embodiments, other user-aware networking functions, such as assigning packets to virtual ports or networks, such as virtual local area networks (VLANs) used for processing and forwarding the packets, applying access control lists (ACLs) to ensure that only approved users have access to various resources on the network, etc. are additionally or alternatively moved from the network devices in the communication network to the central location in the cloud edge. Moving the user-aware networking operations from network devices in the communication network to a remote central location, such as the cloud edge, simplifies the network devices in the communication network, making the network devices less costly, easier to develop and maintain, etc. thereby reducing the cost while improving maintainability of the communication network, in at least some embodiments.

In an embodiment, the communication network comprises, or is part of, a physical underlay network configured to securely and reliably transmit packets from endpoint devices to the cloud edge, and vice versa, through the communication network. Further, a logical overlay network is layered over the physical underlay network to provide point-to-point connections between the endpoint devices and a network device (sometimes referred to herein as a “cloud edge network device”) that is implemented, or otherwise located, in the cloud edge, to allow at least some networking functions that are typically performed by network devices in the communication network to instead be performed by the network device implemented in the cloud edge. As will be explained in more detail below, in an embodiment, a network device that is coupled to an endpoint device in the communication network is configured to tunnel a packet from the endpoint device to the cloud edge over the overlay network by encapsulating the packet with a tunneling header that includes i) a network address of the cloud edge network device in the cloud edge and ii) an indicator of a network interface via which the packet was received by the network device in the communication network, and transmitting the packet in the physical underlay network towards the cloud edge. The packet is then forwarded trough the physical underlay network, based on the network address of the cloud edge network device in the tunnelling header of the packet, to the cloud edge network device in the cloud edge. Including, in the tunneling header, both i) the network address of the cloud edge network device in the cloud edge and ii) the indicator of the network interface via which the packet was received by the network device in the communication network allows for the packet to be routed, based on the network address of the cloud edge network device in the tunneling header, to the cloud edge network device in the cloud edge and provides network interface information to the cloud edge network device in the cloud edge to enable the cloud edge network device to subsequently forward packets via the overlay network to the endpoint device coupled to the network interface without awareness to an endpoint destination address in the packet by any network device in the physical underlay communication network.

The cloud edge network device is configured to receive and decapsulate packets tunneled from the endpoint devices to the edge cloud via the communication network, and to forward and/or route the packets towards their endpoint destinations based on endpoint destination network addresses included in the packets. In some embodiments, the cloud edge network device is additionally configured to perform one or more networking operations such as assigning packets to virtual ports or networks, such as virtual local area networks (VLANs) used for processing and forwarding the packets, applying access control lists (ACLs) to ensure that only approved users have access to various resources on the network, etc. with respect to the packet. The cloud edge network device is configured to, after performing one or more networking operations with respect to a received packet, forward the packet towards destination of the packet. If the destination of the packet is an endpoint device in the communication network, the cloud edge network device tunnels the packet to the endpoint device in the communication network by adding a tunneling header to the packet, where the tunneling header includes i) a network address of the network device coupled to the endpoint device in the communication network and ii) an indicator of a network interface via which the packet is to be transmitted to the endpoint device by the network device in the communication network. Including, in the tunnel header, both i) the network address of the network device coupled to the endpoint device in the communication network and ii) the indicator of the network interface via which the packet is to be transmitted to the endpoint device by the network device in the communication network allows for the encapsulated packet to be routed to the first network device through the communication network and for the packet to be transmitted from the first network device to the endpoint device using the tunnelling header and without awareness to the network address of the endpoint device by any network device in the physical underlay communication network.

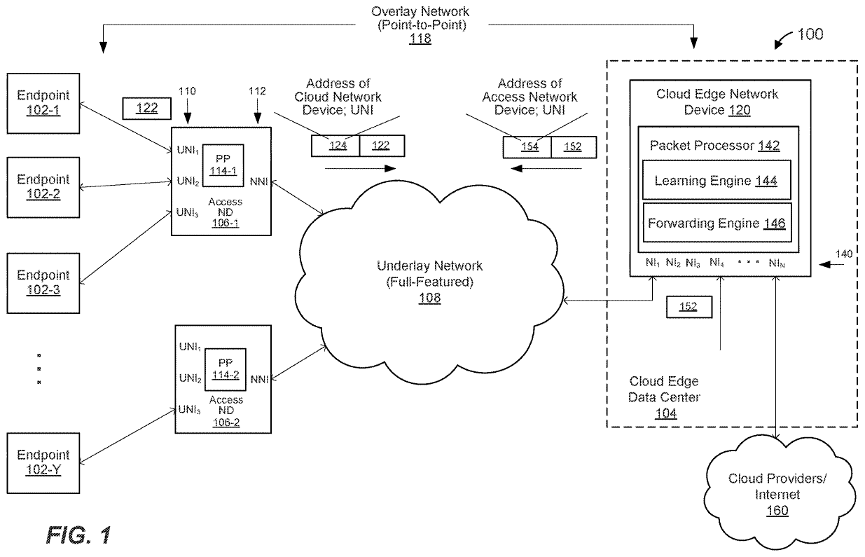

FIG. 1 is a simplified diagram of an example communication system 100 in which packets are transmitted via an overlay network between a cloud edge and endpoint device, and forwarding of the packets to packet destinations is performed at the cloud edge, according to an embodiment. The communication system 100 includes a plurality of endpoint devices 102 communicatively coupled to a cloud edge data center 104 via access network devices (e.g., access switches and/or routers) 106 and a communication network 108. The access network devices 106 are coupled to the communication network 108, as illustrated in FIG. 1, or are parts of the communication network 108, in various embodiments. The endpoint devices 102 include various user devices such as computers, printers, internet of things (IoT) devices, televisions, gaming systems, etc., in various embodiments. The endpoint devices 102 also include wireless connectivity devices, such as WiFi access points (APs), base-stations including radio hardware units (RUs) such as 4G RUs, 5G RUs, etc., in some embodiments. The communication network 108 comprises an access network at least partially located in a facility or a building, and the endpoint devices 102 correspond to devices throughout the facility of the building. As an illustrative example, the communication network 106 is located in an office building, and the endpoint devices 102 correspond to computers in different workstations (e.g., offices, cubicles, etc.), printers, etc. throughout the office building. As another illustrative example, the communication network 106 is located in a multi-family residential building, and the endpoint devices 102 correspond to computers, televisions, gaming systems, etc., throughout the residential building. As another illustrative example, the communication network 106 is located in a healthcare facility, and the endpoint devices 102 correspond to medical equipment, computers, televisions, etc. throughout the healthcare facility.

In an embodiment, the endpoint devices 102 are associated with an entity, such as enterprise or an organization, sometimes referred to herein as “organization”. In some embodiments, respective sets of endpoint devices 102 are associated with respective ones of different entities or organizations. For example, respective sets of endpoint devices 102 are associated with respective ones of different enterprise organization that are located in a same building or facility, in an embodiment. In an embodiment, the cloud edge data center 104 serves the respective one or more organizations. For example, the cloud edge data center 104 includes a plurality of severs that host applications, store data, perform computing, etc. for the respective one or more organizations.

The communication network 108 includes an enterprise access network, such as a local area network (LAN) and/or a wide area network (WAN) that is operated and/or managed by an entity or an organization. In an embodiment, the communication network 108 comprises a data layer (Layer 2 in a networking protocol stack) communication network, such as an Ethernet communication network, in an embodiment. In another embodiment, at least a part of the communication network 108 is a network layer (Layer 3, one layer above Layer-2, in the networking protocol stack) communication network. In other embodiments, the communication network 106 additionally or alternatively operates at other suitable layers (e.g., application layer that corresponds to Layer 4, one layer above Layer 3, of the network protocol stack. In some embodiments, the communication network 108 includes a carrier network that is managed by a carrier services provider, for example.

An access network device 106 includes a plurality of user network interfaces (UNIs) 110 for coupling to endpoint devices 102, one or more network-network interfaces (NNI) 112 for coupling to other network devices in the communication network 108, and a packet processor 114 configured to process packets received via ones of the UNIs 110 and NNI 112 and to cause the packets to be transmitted via other ones of the UNIs 110 and NNI 112. In the embodiment illustrated in FIG. 1, a first access network device 106-1 includes three UNIs 110 respectively coupled to respective ones of three endpoint devices 102 and a second access network device 106-2 includes three UNIs 110 with one of the UNIs 112 coupled to the endpoint device 102-y. Although the access network devices 106-1, 106-2 are illustrated in FIG. 1 as each comprising three UNIs 110, the access network devices 106-1 and/or the access network device 106-2 comprises a suitable number of UNIs 112 different than three UNIs 110, in other embodiments. As just an example, each of the network device 106-1, 106-2 comprises forty-eight UNIs 110 (not shown in FIG. 1) and is coupled to a maximum of forty-eight endpoint devices 102 (not shown in FIG. 1), in an embodiment. Further, although the communication network 106 is illustrated in FIG. 1 as including two access network devices 106 coupled to endpoint devices 102, the communication system 100 comprises a different number (e.g., 1, 3, 4, 5, 6, etc.) of access network devices 106 coupled to endpoint devices 102 in other embodiments.

In an embodiment, the communication network 108 serves as a physical underlay network to an overlay network 118, and the communication network 108 is sometimes referred to as an “underlay network 108.” The overlay network 118 is a logical point-to-point network that is layered over the underlay network 108 to connect endpoint devices 102 to a cloud edge network device 120 in the cloud edge datacenter 104. In an embodiment, the cloud edge network device 120 is at least partially implemented in software that runs on one or more servers (e.g., server central processing units (CPUs), not shown) in the cloud edge data center 104. In some embodiments, the cloud edge network device 120 includes one or more hardware accelerators that the cloud edge network device 120 utilizes to perform more time-critical operations. The one or more hardware accelerators are implemented on one or more integrated circuits, for example. In an embodiment, the one or more hardware accelerators are implemented on one or more smart network interface cards (NICs) in the cloud edge data center 104. Additionally or alternatively, in some embodiments, the cloud edge network device 120 comprises one or more dedicated network devices (e.g., switches, routers, etc.) configured to perform packet processing (e.g., high speed forwarding) for high bandwidth traffic, for example. Although the network device 120 is generally described herein as being implemented at the cloud edge (e.g., at the cloud edge data center 104 at the cloud edge), and the network device 120 is generally referred to herein as a “cloud edge network device 120”, the network device 120 is implemented or otherwise located at a remote location other than at the cloud edge, in some embodiments. For example, the network device 120 is a cloud device implemented in the cloud (e.g., public cloud or private cloud belonging to an organization), in some embodiments.

The cloud edge network device 120 implements one or more virtual network devices, such as one or more virtual switches or routers, in the cloud edge data center 104, in an embodiment. The one or more virtual network devices implemented by the cloud edge network device 120 include respective one or more virtual network devices corresponding to one or more organizations supported by the cloud edge datacenter 104, in an embodiment. As will be explained in more detail below, the respective virtual network switches are configured to forward packets originated by the endpoint devices 102 associated with the respective one or more organizations to appropriate servers in the cloud edge data center 104, to other endpoint devices 102 associated with the organization, to other cloud locations (e.g., in private or public cloud) external to the cloud edge data center 104, etc., in various embodiments. In an embodiment, the cloud edge network device 120 at the cloud edge data center 104, or one or more devices implemented separately from the cloud edge network device 120 at the cloud edge data centar 104, additionally or alternatively implements one or more virtual base-stations configured to forward packets to and from endpoint devices 102 that correspond to WiFi access points (APs), base-stations including radio hardware units (RUs) such as 4G RUs, 5G RUs, etc. and/or perform other networking functions typically implemented in physical base-stations. For example, respective virtual base-stations for respective mobile operators are implemented, or otherwise located, at the cloud edge data center 104 and are configured to forward packets to and from endpoint devices 102 that correspond to WiFi access points (APs), base-stations including radio hardware units (RUs) such as 4G RUs, 5G RUs, etc. associated with the respective mobile operators, in some embodiments.

In an embodiment, the underlay network 108 includes a plurality of network devices, e.g., including the access network devices 106, generally configured to forward packets from the endpoint devices 102 to the cloud edge network device 120 in the could edge data center 104 and vice versa. The network devices of the underlay network 108 are generally full-featured network devices, in an embodiment. For example, the network devices of the underlay network 108 provide a full, high-bandwidth data paths between the endpoint devices 102 and the cloud edge network device 120 in the cloud edge data center 104, in an embodiment. As another example, the network devices of the underlay network 108 implement various networking functions such as one or more of quality or services (QoS) operation such as shaping and policing operations, support flexible forwarding schemes, such as segment routing over internet protocol version six (SRv6), virtual private wire service (VPWS), link aggregation group (LAG) and/or equal-cost multi-path (ECMP) load balancing techniques, implement operation, administration and management (OAM) network operations, provide media access control security (MACsec), provide power over ethernet (PoE), as needed, to the endpoint devices 102, perform various telemetry and/or other monitoring functions, implement timing synchronization, such as precision timing protocol (PTP) and/or synchronous Ethernet (SyncE) synchronization, etc. However, the network devices of the underlay network 108 are simplified with respect to network devices utilized in typical communication networks in that at least some user-aware networking functions implemented by typical network devices are offloaded to the cloud edge network device 120 in the cloud edge data center 104, in an embodiment. For example, as explained in more detail below, user-aware address learning, lookup and forwarding operations, such as user-aware Layer 2, Layer 3, and/or Layer 4 address learning, lookup and forwarding operations are offloaded from the network devices of the underlay network 108 to the cloud edge network device 120 in the cloud edge data center 104, in an embodiment. Additionally or alternatively, as also explained in more detail below, one or more of i) user classification and access control list (ACL) application operations, ii) virtual local area network (VLAN) assignment operations, iii) micro-segmentation operations, iv) edge router and/or software defined networking, such as software defined wide area network (SD-WAN) operations, etc. are offloaded from the network devices of the underlay network 108 to the cloud edge network device 120 in the cloud edge data center 104, in an embodiment. In some embodiments, functionality (e.g., firewall functionality) typically implemented by an edge router in a communication network, such as an edge router utilized to connect an enterprise network to an external network, are offloaded from the communication network to the cloud edge network device 120 in the cloud edge data center 104. In this case, the functionality of the edge router in the communication network is simplified, in some embodiments, or the edge router is entirely omitted from the communication network. Because at least some user-aware networking functions are offloaded from the network devices of the underlay network 108 to the cloud edge network device 120 in the cloud edge data center 104, at least some of the network devices of the underlay network 108 (e.g., at least the access network devices 106 of the underlay network 108) are generally simplified, less costly, consume less power, are easier to configure and maintain, etc. as compared to typical access network devices that implement such user-aware networking functions, in at least some embodiments.

With continued reference to FIG. 1, in an embodiment, the access network devices 106 are configured to receive packets from the endpoint devices 102 via the UNIs 110 and to forward the packets via NNIs 112 to the cloud edge network device 120 in the cloud edge data center 104. In an embodiment, when an access network device 106 receives a packet originated by an endpoint device 102, the access network device 106 encapsulates the packet with a tunnel header that includes i) a network address corresponding to the cloud edge network device 120 in the cloud edge data center 104 and ii) an indicator of a UNI 110 via which the packet was received by the access network device 106, and to transmit the encapsulated packet via an NNI 112 towards the cloud edge data center 104. As an example, the access network device 106-1 is illustrated in FIG. 1 as receiving a packet 122 via the UNIT 110 from the endpoint device 102-1. The packet 122 is a Layer 2 frame (e.g., an Ethernet frame), in an embodiment. The packet 122 includes a Layer-2 header that, in turn, includes a source network address (e.g., a source MAC address) of the endpoint device 102-1 and a destination network address (a destination MAC address) corresponding to a destination of the packet 122. The packet processor 114-1 of the access network device 106-1 encapsulates the packet 122 with a tunneling header 124 that includes i) a network address corresponding to the cloud edge network device 120 in the cloud edge data center 104 and ii) an indicator of the UNIi 110 via which the packet was received by the access network device 106, and to transmit the encapsulated packet via the NNI 112 towards the cloud edge data center 104. In some embodiments, the tunneling header 124 includes additional information used for transmission of the packet 122 in the underlay network 108. For example, the tunneling header 124 includes an indicator of a priority, such as a quality of service (QoS) indicator, used for transmission of the packet 122 in the underlay network 108.

In some embodiments, the network address corresponding to the cloud edge network device 120 included in the tunneling header 124 corresponds to a Layer 3 network address. For example, the network address corresponding to the cloud edge network device 120 included in the tunneling header 124 is an IP address. In some embodiments, the network address corresponding to the cloud edge network device 120 included in the tunneling header 124 corresponds to a virtual network device implemented by the cloud edge network device 120, corresponding to a particular organization. For example, the packet processor 114-1 determines the network address to be included in the tunneling header 124 based on the source network address included in the packet 122, wherein the source network address included in the packet 122 indicates that the endpoint network device 102-1 that transmitted the packet 122 is associated with the particular organization. In another embodiment, for example if the access network device 106 is operated by a particular organization and is coupled to only endpoint devices 102 associated with the particular organization, the packet processor 114-1 is configure to include, in the tunneling header 124, a network address corresponding to a to a virtual network device, implemented by the cloud edge network device 120, corresponding to the particular organization without analyzing the source network address in the packet 122.

In an embodiment, the packet processor 114-1 is generally configured to transmit packets received from the endpoint devices 102 to the cloud edge network device 120 regardless of the endpoint destinations of the packets. For example, the packet processor 114-1 is configured to transmit packets received from the endpoint devices 102 to the cloud edge network device 120 without performing local switching or routing of the packets between endpoint devices 102 coupled to the access network devices 106. Thus, for example, the packet processor 114-1 is configured to transmit the packet 122 received from the endpoint device 102-1 to the cloud edge network device 120 even if the destination of the packet 122 is another endpoint device 102 coupled to, for example, the access network device 106-1 or the access network device 106-2, in an embodiment. In an embodiment, because the packet processor 114-1 is generally configured to transmit packets received from the endpoint devices 102 to the cloud edge network device 120 regardless of the endpoint destinations of the packets, the packet processor 114-1 encapsulates the packet 122, including adding the network address corresponding to the cloud edge network device 120 in the cloud edge data center 104 to the tunnel header 122, without analyzing the destination network address in the packet 122.

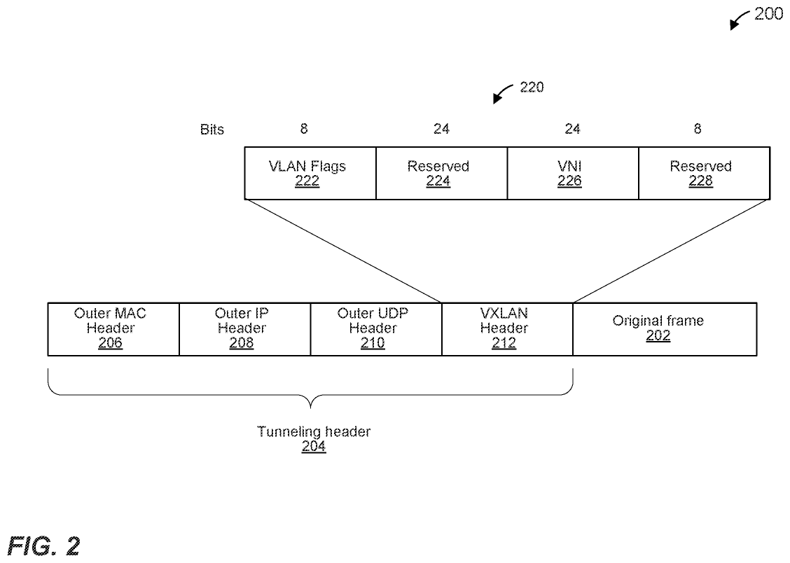

In an embodiment, the packet processor 114-1 utilizes a virtual extensible local area network (VxLAN) encapsulation to encapsulate the packet 122, and the tunneling header 124 corresponds to a VxLAN header. Example encapsulation format based on VxLAN header encapsulation, performed by the packet processor 114-1 according to an embodiment, is described in more detail below with reference to FIG. 2. In another embodiment, the packet processor 114-1 utilizes segment routing over internet protocol version 6 (SRv6) to encapsulate, and the tunneling header 124 is an SRv6 extension header. In another embodiment, the packet processor 114-1 utilizes another suitable tunneling protocol to encapsulate the packet 122. In an embodiment, the encapsulated packet 122 is transmitted, using the network address corresponding to the cloud edge network device 120 in the tunneling header 124 encapsulating the packet 122, through the underlay network 108 to the cloud edge data center 104 and is received by the cloud edge network device 120.

In some embodiments, the access network device 106 is configured to, prior to transmitting packets to the cloud edge network device 120, performing an authentication procedure with the cloud edge network device 120 to authenticate the access network device with a cloud provider in the cloud edge. In an embodiment, prior to authenticating with the cloud provider in the cloud edge, the access network device is not provided full-bandwidth communication with the cloud edge. For example, only a limited bandwidth communication link is provided for performing authentication between the access network device 106 and the cloud provider at the cloud edge. Subsequently, after completion of successful authentication with the cloud provider at the cloud edge, the access network device 106 is provided full bandwidths (e.g., according to a service level agreement) for communication with the cloud provider, and the cloud edge network device 120, at the cloud edge.

The cloud edge network device 120 is illustrated in FIG. 1 as including a plurality of network interfaces 140 and a packet processor 142. The packet processor 142 includes a learning engine 144 and a forwarding engine 146, in the illustrated embodiment. The learning engine 144 is configured to learn associations network interfaces 140 of the cloud edge network device 120 via which packets are received and address information in the received packets. In an embodiment, the learning engine 144 is configured to receive, via a network interface 140, a packet transmitted via the underlay network 108 and to learn, based on information in an original header of the packet and a tunnel header of the packet, an association between the network interface 140 via which the packet was received and i) a network address (e.g., MAC address) of an endpoint device 102 that originated the packet, ii) a network address (e.g., IP address) of an access network device 106 that transmitted the packet via the underlay network 108, and iv) a UNI 110, of the access network device 106, via which the access network device 106 is coupled to the endpoint device 102. The packet processor 142 is configured to utilize the information learned by the learning engine 144 to subsequently forward packets to the endpoint devices 102, in an embodiment.

In an embodiment, the cloud edge network device 120 receives a packet 152 via a network interface 140. The packet 152 is transmitted to the cloud edge network device 120 via the underlay network 108, in an embodiment. In another embodiment, the packet 152 is transmitted to the cloud edge network device 120 from a network external to the underlay network 108. The packet 152 is encapsulated with one or more encapsulation and/or tunneling headers (not shown) used for transmission of the packet 152 to the cloud edge network device 120, in some embodiments. For example, if the packet 152 is a packet transmitted to the cloud edge network device 120 from an endpoint device 102 via the underlay network 108, the packet 152 includes a tunneling header such as the header 124 described in connection with transmission of the packet 122 via the underlay network 108, in an embodiment.

The packet processor 142 is configured to process the packet 152 and to determine a destination of the packet 152, in an embodiment. For example, the packet processor 142 is configured to decapsulate the packet 152 and to determine a destination of the packet 152 based on a destination network address (e.g., MAC address or another suitable network address) included in an original header of the packet 152. In an embodiment, the forwarding engine 146 is configured to perform one or more lookups in one or more forwarding tables (e.g., the forwarding table populated by the learning engine 144) based on the destination network address in the packet 152, and the packet processor 142 forwards the packet 152 to the destination based on the information corresponding to the destination address obtained by the forwarding engine 146 based on the one or more lookups. In an embodiment, the forwarding engine 146 determines a virtual network interwork based on the destination address, where the virtual network interface corresponds, or maps to, a network interface 140 via which the packet is to be transmitted from the cloud edge network device 120. In an embodiment, if the destination of the packet 152 is within the cloud edge data center 104 (e.g. a sever located in the cloud edge data center 104), then the packet processor 142 forwards the packet 152 to the destination via a network internal to the cloud edge data center 104. Otherwise, if the destination of the packet 152 is external to the cloud edge data center 104, the packet processor 142 forwards the packet 152 to a network that is external to the cloud edge data center 104. For example, if the destination of the packet 152 is a cloud location external to the cloud edge data center 104, the packet processor 142 routes (e.g., using a routing table) the packet to a location in the cloud provider/internet network 160, in an embodiment.

On the other hand, if the destination of the packet 152 is an endpoint device 102 coupled to the underlay network 108, the packet processor 152 forwards the packet to the endpoint device 102 via the underlay network 108. In this case, the packet processor 152 encapsulates the packet 152 with a tunneling header 154 so that the encapsulated packet 152 can be forwarded to the endpoint device 102 via the overlay network 118 layered over the underlay network 108, in an embodiment. In an embodiment, packet processor 144 generates the tunneling header 154 to include i) a network address (e.g., IP address) of the access network device 106 that is coupled to the endpoint device 102 and ii) an indicator of a UNI 110, of the access network device 106, via which the packet is to be transmitted by the access network device 106 to the endpoint device 102. In some embodiments, the tunneling header 154 includes additional information used for transmission of the packet 152 in the underlay network 108. For example, the tunneling header 154 includes an indicator of a priority, such as a quality of service (QoS) indicator, used for transmission of the packet 152 in the underlay network 108. The packet processor 144 encapsulates the packet 152 with the tunneling header 154 and transmits the encapsulated packet via the corresponding network interface 140. The encapsulated packet 152 is then transmitted, using the network address of the access network device 106 in the tunneling header 154, via the underlay network 108 to the access network device 106. The network device 106 is configured to receive and decapsulate the encapsulated packet 152, and to transmit the decapsulated packet 152 to the endpoint device 102 via the UNI 110 indicated in the tunneling header 154, in an embodiment. Thus, because the tunneling packet 154 includes both i) the network address (e.g., IP address) of the access network device 106 that is coupled to the endpoint device 102 and ii) the indicator of the UNI 110, of the access network device 106, via which the packet is to be transmitted by the access network device 106 to the endpoint device 102, the packet 152 is transmitted from the cloud edge network device 120 to the endpoint device 122 without awareness to any network address (e.g., MAC address) of the endpoint device 122, in an embodiment.

In some embodiments, the cloud edge network device 120 is configured to implement one or more networking functions in addition to the learning and forwarding operations. For example, the cloud edge network device 120 is configured to apply access control lists to packets received from the endpoint device 102 and/or directed to the endpoint devices 102 to ensure that only approved users are given access to the underlay network 108 and/or to other resources external to the underlay network 108. As another example, the cloud edge network device 120 is configured to assign VLANs to packets, and to broadcast/multicast packets based on the VLANs assigned to the packets. As yet another example, the cloud edge network device 120 is configured to apply security access lists (SAL) to packets received from the endpoint device 102 and/or directed to the endpoint devices 102 and/or generate security access tags (SGTs) for the packets to packets received from the endpoint device 102 and/or directed to the endpoint devices 102. In an embodiment, the cloud edge network device 120 is configured to maintain different VLANs, ACLs, SAL, etc. corresponding to different organizations supported by the cloud edge network device 120, and to apply respective VLANs, ACLs, AGLs to packets originated from and/or directed endpoint devices 102 associated with the corresponding organizations. Such VLANs, ACLs, SALs, etc. are configured by IT personnel of the respective organizations, for example via a cloud service portal provided by a cloud provider of the cloud edge network device 120, for example. In some embodiments, the cloud edge network device 120 is configured to perform network address translation (NAT) and/or to utilize dynamic host configuration protocol (DHCP) to obtain IP addresses and other related configuration information for the endpoint devices 102, and to provide the IP addresses and other related configuration information to the endpoint devices 102 via the underlay network 108.

In various embodiments, because user-aware networking operations, such as learning, forwarding, routing, control and security operations., etc. are performed by the cloud edge network device 120 at the cloud edge data center 104, the access network devices 106 and, in some embodiments, other network devices in the underlay network 108, are generally simple, less costly, easier to develop and maintain, etc. as compared to typical network devices (e.g., typical access switches) in typical communication networks, such as typical enterprise communication networks.

FIG. 2 is an example encapsulated packet 200, according to an embodiment. In an embodiment, the encapsulated packet is transmitted by an access network device 106 towards the cloud edge network device 120 in the cloud edge data center 104. For example, the network device 106-1 generates and transmits the encapsulated packet 200 towards the cloud edge network device 120 in the cloud edge data center 104, in an embodiment. In another embodiment, the cloud edge network device 120 in the cloud edge data center 104 generates and transmits the encapsulated packet 200 towards an access network device 106 (e.g., the access network device 106-1) coupled to an endpoint device 102 (e.g., the endpoint device 102-1) that corresponds to the destination of data in the encapsulated packet 200.

The encapsulated packet 200 includes an original frame (sometimes referred herein as “packet”) 202. The original frame 202 is a Layer-2 frame generated by an endpoint device 102 (e.g., the endpoint device 102-1), in an embodiment. In an embodiment, the original frame 202 includes a header (e.g., Layer-2 header) that includes a source network address of an endpoint device (e.g., an endpoint device 102) that generated the original frame 202) and a destination network of address of an endpoint device (e.g., another endpoint device 102) indicating a final destination of the original frame 202. In some embodiments, the header of the original frame 202 includes additional information, such as an indicator of a priority (e.g., quality of service (QoS) indicator) associated with the original frame 202. The encapsulated packet 200 also includes a tunneling header tunneling header 204. The tunneling header 204 is generally formatted according to the VxLAN encapsulation, or other suitable, format. The tunneling header 204 includes an outer MAC header 206, an outer IP header 208, an outer UDP header 210 and a VxLAN header 212. The VxLAN header 212 includes a plurality of header fields 220. An example number of bits in each of the fields 220, according to an embodiment, is indicated in FIG. 2 above the corresponding field 220. The plurality of field 220 includes a VLAN flags field 222 (8 bits), a first reserved field 224 (24 bits), a VxLAN network identifier (VNI) field 224 (24 bits) and a second reserved field 226 (8 bits).

In an embodiment, the outer IP header 208 includes a network address used for transmission of the encapsulated packet 200 over the overlay network 118 by network devices in the underlay network 108. For example, in an embodiment in which the encapsulated packet 200 is transmitted from an access network device 106 (e.g., the access network device 106-1) to the cloud edge network device 120, the IP header 208 includes a network address (e.g., IP address) of the cloud edge network device 120, or of a virtual network device implemented by the cloud edge network device 120. As another example, in an embodiment in which the encapsulated packet 200 is transmitted from the cloud edge network device 120 to an access network device 106 (e.g., the access network device 106-1), the outer IP header 208 includes a network address (e.g., IP address) of the access network device 106. In some embodiments, the outer IP header 208 includes additional information used for transmission of the encapsulated packet 200 in the underlay network 108. For example, the outer IP header 208 includes an indicator of a priority, such as a quality of service (QoS) indicator, used for transmission of the packet in the underlay network 108. In an embodiment, the network device (e.g., an access network device 106 or the cloud edge network device 120) that generates the encapsulated packet 200 is configured to copy a priority (e.g., QoS) indicator from the header of the original frame 202 to the outer IP header 208).

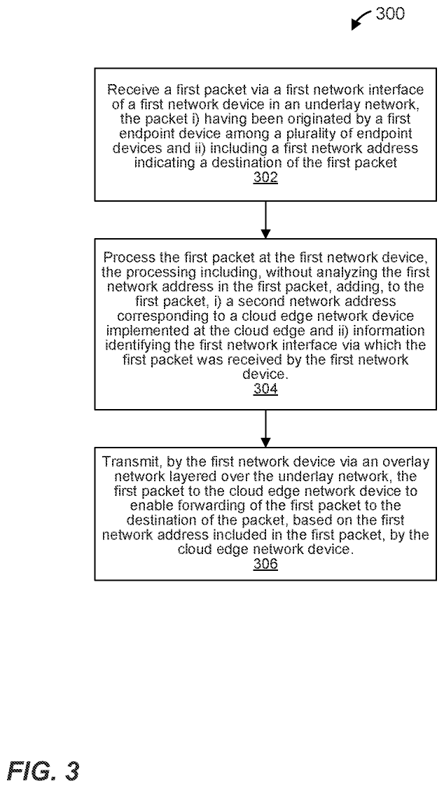

FIG. 3 is a flow diagram of an example method 300 for transmitting packets in an underlay network that connects a plurality of endpoint devices to a cloud edge, according to an embodiment. The method 300 is implemented by an access network device 106 of FIG. 1, in some embodiments, and the method 300 is described with reference to FIG. 1 for ease of explanation. In other embodiments, the method 300 is implemented by suitable network devices different from the access network devices 106 of FIG. 1.

At block 302, a first packet is received via a first network interface of a first network device. In an embodiment, the packet is a packet that was originated by a first endpoint device among the plurality of endpoint devices. For example, the packet 110 originated by the endpoint device 102-1 is received. In another embodiment, the original frame 202 of FIG. 2 is received. The first packet includes a first network address indicating a destination of the first packet. In an embodiment, the first packet includes a header (e.g., a Layer-2 header) which, in turn, includes the first network address (e.g., a MAC address) indicating the destination of the first packet.

At block 304, the first packet is processed at the first network device. In an embodiment, processing of the first packet includes, without analyzing the first network address in the first packet, adding, to the first packet, i) a second network address corresponding to a cloud edge network device implemented at the cloud edge and ii) information identifying the first network interface via which the first packet was received by the first network device. For example, the first network device encapsulates the first packet with a tunneling header, where the tunneling header includes i) a second network address corresponding to a cloud edge network device implemented at the cloud edge and ii) information identifying the first network interface via which the first packet was received by the first network device.

At block 306, the first packet is transmitted, via an overlay network layered over the underlay network, from the first network device to the cloud edge network device in the cloud edge to enable forwarding of the first packet to the destination of the packet, based on the first network address included in the first packet, by the cloud edge network device at the cloud edge. Adding, to the first packet, both i) the network address of the cloud edge network device in the cloud edge and ii) the indicator of the network interface via which the first packet was received by the first network device in the underlay network allows for the first packet to be routed, based on the network address of the cloud edge network device in the first packet, through the underlay network to the cloud edge network device and provides network interface information to the cloud edge network device to enable the cloud edge network device to subsequently forward packets via the overlay network to the endpoint device coupled to the first network interface of the first network device in the underlay network without awareness to an endpoint destination address in the packets by any network device in the underlay network.

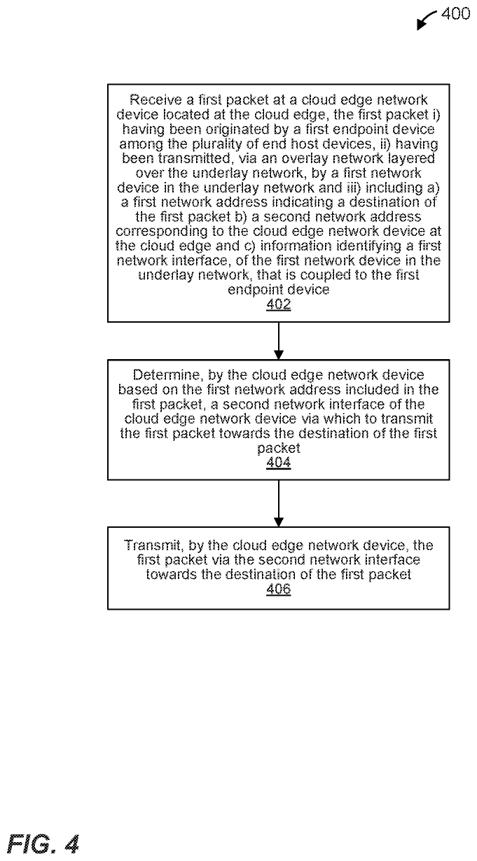

FIG. 4 is a flow diagram of an example method 400 for processing packets at a cloud edge connected to a plurality of endpoint devices by an underlay network, according to an embodiment. The method 400 is implemented by the cloud edge network device 120 of FIG. 1, in some embodiments, and the method 400 is described with reference to FIG. 1 for ease of explanation. In other embodiments, the method 400 is implemented by suitable network devices different from the cloud edge network device 120 of FIG. 1.

At block 402, a first packet is received at a cloud edge network device located at the cloud edge. In an embodiment, the encapsulated packet 122 of FIG. 1 is received. In another embodiment, the packet 152 of FIG. 1 is received. In an embodiment, the first packet is a packet originated by a first endpoint device among the plurality of endpoint devices. In an embodiment, the first packet i) is transmitted, via an overlay network layered over the underlay network, by a first network device (e.g., the access network device 106-1 of FIG. 1) in the underlay network and i) includes a) a first network address indicating a destination of the first packet b) a second network address corresponding to the cloud edge network device at the cloud edge and c) information identifying a first network interface, of the first network device in the underlay network, that is coupled to the first endpoint device.

At block 404, the cloud edge network device determines, based on the first network address included in the first packet, a second network interface of the cloud edge network device via which to transmit the first packet towards the destination of the first packet. In an embodiment, the cloud edge network device performs, based on the first network address included in the first packet, one or more lookups in one or more forwarding and/or routing tables maintained by the cloud edge network device to determine a network interface via which to transmit the first packet. In an embodiment, the cloud edge network device determines, based on the first network address included in the first packet, a virtual network interface and maps the virtual network interface to a physical network interface of the cloud edge network device via which to transmit the first packet.

At block 406, the cloud edge network device transmits the first packet via the second network interface of the first network device towards the destination of the first packet. In some embodiments, the cloud edge network device is configured to perform additional user-aware network operations with respect to the first packet, such as assigning the first packet to a virtual port or a virtual network, e.g., a VLAN, used for processing and forwarding the first packet, applying access control lists (ACLs) to the first packet determine whether to forward or to drop the first packet, generating a security tag for the packet, etc. In at least some embodiments, because the cloud edge network device performs forwarding and other networking operations that are performed by typical network devices in a communication network, network devices used to tunnel the first packet to the cloud edge network device are less costly, easier to develop and maintain, etc. as compared to typical network devices (e.g., typical access network devices) in typical communication networks, such as typical network devices in typical enterprise networks. In at least some embodiments, because network devices in a communication network, such as an enterprise network, are less complex and easier to develop and maintain, the cost of establishing and operating the communication network is generally decreased while improving maintainability of the communication network.

Embodiment 1: A method for transmitting packets in an underlay network that connects a plurality of endpoint devices to a cloud edge, the method comprising: receiving a first packet via a first network interface of a first network device in the underlay network, the packet i) having been originated by a first endpoint device among the plurality of endpoint devices and ii) including a first network address indicating a destination of the first packet; processing the first packet at the first network device, the processing including, without analyzing the first network address in the first packet, adding, to the first packet, i) a second network address corresponding to a cloud edge network device implemented at the cloud edge and ii) information identifying the first network interface via which the first packet was received by the first network device; and transmitting, by the first network device via an overlay network layered over the underlay network, the first packet to the cloud edge network device in the cloud edge to enable forwarding of the first packet to the destination of the packet, based on the first network address included in the first packet, by the cloud edge network device.

Embodiment 2: The method of embodiment 1, wherein: the first network address is included in a first header of the first packet, and processing the packet includes encapsulating the first packet with a second header, distinct from the first header, the second header including i) the second network address corresponding to a cloud edge network device implemented at the cloud edge and ii) the information identifying the first network interface via which the first packet was received by the first network device.

Embodiment 3: The method of embodiment 2, wherein encapsulating the packet comprises encapsulating the packet based on virtual extensible local area network (VxLAN) protocol encapsulation.

Embodiment 4: The method of embodiment 2, wherein encapsulating the packet comprises encapsulating the packet based on segment routing (SR) over internet protocol encapsulation.

Embodiment 5: The method of any of the embodiments claim 1-4, wherein the first endpoint device is associated with an enterprise organization, and adding information identifying the cloud edge network device comprises adding information identifying a first virtual network access device, among a plurality of virtual network access devices, implemented by the cloud edge network device in the cloud edge, the first network access device configured to perform forwarding of i) packets originated by endpoint devices associated with the enterprise organization and ii) packets directed to endpoint devices associated with the enterprise organization.

Embodiment 6: The method of any of the embodiments claim 1-6, further comprising performing, by the first network device, an authentication procedure with the cloud edge network device in the cloud edge to authenticate the first network device with a cloud provider in the cloud edge.

Embodiment 7: The method of any of the embodiments claim 1-6, further comprising: receiving a second packet via the second network interface of the first network device, wherein the second packet i) is directed to the first endpoint device and ii) includes information identifying the first user network interface of the first network device, processing the second packet with the packet processor of the first network device, the processing including determining, based on the information identifying the first user network interface of the first network device that the packet is to be transmitted via the first network interface of the first network device, and transmitting the second packet via the first network interface to transmit the second packet to the first endpoint device.

Embodiment 8: The method of any of the embodiments claim 1-7, wherein transmitting the first packet via the overlay network to the cloud edge network device in the cloud edge comprises transmitting the first packet via a point-to-point link in the overlay network, the point-to-point link connecting the first endpoint device to the cloud edge network device in the cloud edge.

Embodiment 9: The method of any of the embodiments claim 1-8, wherein receiving the first packet comprises receiving the first packet from one of i) a host computer coupled to the first network device and ii) a wireless resource unit coupled to the first network device.

Embodiment 10: The method of any of the embodiments claim 1-9, wherein transmitting the first packet over the overlay network to the cloud edge network device in the cloud edge comprises transmitting the first packet over the overlay network to a data center in the cloud edge.

Embodiment 11: A first network device in an underlay network that connects a plurality of endpoint devices to a cloud edge, the first network device comprising a plurality of network interfaces, and a packet processor coupled to the plurality of network interfaces, the packet processor configured to: receive a first packet via a first network interface among the plurality of network interfaces, the packet i) having been originated by a first endpoint device among the plurality of endpoint devices and ii) including a first network address indicating a destination of the first packet, process the packet at the first network device, the processing including, without analyzing the first network address in the first packet, adding, to the first packet, i) a second network address corresponding to a cloud edge implemented at the cloud edge and ii) information identifying the first network interface via which the first packet was received by the first network device, cause the packet to be transmitted via an overlay network layered over the underlay network, the first packet to the cloud edge network device in the cloud edge to enable forwarding of the first packet to the destination of the packet, based on the first network address included in the first packet, by the cloud edge network device.

Embodiment 12: The first network device of embodiment 11, wherein the first network address is included in a first header of the first packet, and the packet processor is configured to encapsulate the first packet with a second header, distinct from the first header, the second header including i) the second network address corresponding to a cloud edge network device implemented at the cloud edge and ii) the information identifying the first network interface via which the first packet was received by the first network device.

Embodiment 13: The first network device of embodiment 12, wherein the packet processor is configured to encapsulate the first packet based on virtual extensible local area network (VxLAN) protocol encapsulation.

Embodiment 14: The first network device of embodiment 12, wherein the packet processor is configured to encapsulate the first packet based on segment routing (SR) over internet protocol encapsulation.

Embodiment 15: The first network device of any of the embodiments 11-14, wherein the first endpoint device is associated with an enterprise organization, and the packet processor is configured to add, to the first packet, the information identifying the cloud edge network device at least by adding, to the first packet, information identifying a first virtual network access device, among a plurality of virtual network access devices, implemented by the cloud edge network device in the cloud edge, the first network access device configured to perform forwarding of i) packets originated by endpoint devices associated with the enterprise organization and ii) packets directed to endpoint devices associated with the enterprise organization.

Embodiment 16: The first network device of any of the embodiments 11-15, wherein the packet processor is further configured to perform an authentication procedure with the cloud edge network device in the cloud edge to authenticate the first network device with a cloud provider in the cloud edge.

Embodiment 17: The first network device of any of the embodiments 11-16, wherein the packet processor is further configured to: receive a second packet via the second network interface of the network device, wherein the second packet i) is directed to the first endpoint device coupled to the access network and ii) includes information identifying the first user network interface of the first network device, process the second packet with the packet processor of the network device, the processing including determining, based on the information identifying the first user network interface of the first network device that the packet is to be transmitted via the first network interface of the first network device, and cause the second packet to be transmitted via the first network interface to transmit the second packet to the first endpoint device.

Embodiment 18: The first network device of any of the embodiments 11-17, wherein the packet processor is configured to cause the first packet to be transmitted to the cloud edge network device via a point-to-point link in the overlay network, the point-to-point link connecting the first endpoint device to the cloud edge network device in the cloud edge.

Embodiment 19: The first network device of any of the embodiments 11-18, wherein the packet processor is configured to receive the first packet from one of i) a host computer coupled to the first network device and ii) a wireless resource unit coupled to the first network device.

Embodiment 20: The first network device of any of the embodiments 11-19, wherein the packet processor is configured to cause the first packet to be transmitted over the overlay network to a data center in the cloud edge.

Embodiment 21: A method for processing packets at a cloud edge connected to a plurality of endpoint devices by an underlay network, the method comprising: receiving a first packet at a cloud edge network device located at the cloud edge, the first packet i) having been originated by a first endpoint device among the plurality of endpoint devices, ii) having been transmitted, via an overlay network layered over the underlay network, by a first network device in the underlay network and iii) including a) a first network address indicating a destination of the first packet b) a second network address corresponding to the cloud edge network device at the cloud edge and c) information identifying a first network interface, of the first network device in the underlay network, that is coupled to the first endpoint device; determining, by the cloud edge network device based on the first network address included in the first packet, a second network interface of the cloud edge network device via which to transmit the first packet towards the destination of the first packet; and transmitting, by the cloud edge network device, the first packet via the second network interface of the cloud edge network device towards the destination of the first packet.

Embodiment 22: The method of embodiment 21, wherein receiving the first packet comprises receiving an original packet generated by the first endpoint device and encapsulated with a tunneling header at the first network device in the underlay network, wherein the tunneling header includes i) the second network address corresponding to the cloud edge network device at the cloud edge and ii) the information identifying a first network interface, of the first network device, that is coupled to the first endpoint device.

Embodiment 23: The method of embodiment 22, wherein receiving the first packet comprises receiving the original packet encapsulated with a tunneling header based on virtual extensible local area network (VxLAN) protocol encapsulation.

Embodiment 24: The method of embodiment 22, wherein receiving the first packet comprises receiving the original packet encapsulated with a tunneling header based on segment routing (SR) over internet protocol encapsulation.

Embodiment 25: The method of any of the embodiments 21-24, wherein receiving the first packet over the overlay network by the cloud edge network device in the cloud edge comprises receiving the first packet over the overlay network by the cloud edge network device located at a cloud edge data center in the cloud edge.

Embodiment 26: The method of any of the embodiments 21-25, wherein: the first packet further includes a third network address corresponding to the first endpoint device, and the method further comprises, prior to transmitting the first packet, performing, by the cloud edge network device, one or more of i) applying an access control list to the first packet based on the third network address included in the first packet, ii) applying a security access list to the first packet based on the third network address included in the first packet and iii) determining a virtual local area network (VLAN) to which the first packet belongs based on the third network address included in the first packet.

Embodiment 27: The method of any of the embodiments 21-26, wherein: the first packet further includes i) a third network address corresponding to the first endpoint device and ii) a fourth network address corresponding to the first network device in the underlay network, and the method further comprises populating, by the cloud edge network device, an entry in an association between at least i) the third network address corresponding to the first endpoint device, ii) fourth network address corresponding to the first network device in the underlay network and iii) the information identifying the first network interface, of the first network device in the underlay network, that is coupled to the first endpoint device.

Embodiment 28: The method of any of the embodiments 21-27, further comprising: receiving a second packet at the cloud edge network device, performing a lookup based on a destination network address included in the second packet to determine that the destination network address corresponds to the first endpoint device, encapsulating the second packet with a tunneling header, the tunneling header including i) the fourth network address corresponding to the first network device in the underlay network and ii) the information identifying first network interface, of the first network device in the underlay network, that is coupled to the first endpoint device, and transmitting, via the overlay network, the second packet to the first network device for subsequent transmission of the second packet, via the first network interface of the first network device, to the first endpoint device.

Embodiment 29: The method of embodiment 28, wherein transmitting the second packet via the overlay network comprises transmitting the second packet via a point-to-point link in the overlay network, the point-to-point link between the cloud edge network device and the first endpoint device.

Embodiment 30: The method of embodiment 28 or 29, wherein transmitting the second packet over the overlay network comprises tunneling the second packet to the first network device for subsequent transmission of the second packet, via the first network interface of the first network device, to one of i) a host computer coupled to the first network device and ii) a wireless resource unit coupled to the first network device.

Embodiment 31: A cloud edge network device located at a cloud edge connected to a plurality of endpoint devices to by an underlay network, the cloud edge network device comprises: a plurality of network interfaces and a packet processor coupled to the plurality of network interfaces, the packet processor configured to: receive a first packet received by the first network device via a first network interfaces among the plurality of network interfaces, the first packet i) having been originated by a first endpoint device among the plurality of endpoint devices, ii) having been transmitted, via an overlay network layered over the underlay network, by a first network device in the underlay network and iii) including a) a first network address indicating a destination of the first packet b) a second network address corresponding to the cloud edge network device at the cloud edge and c) information identifying a first network interface, of the first network device in the underlay network, that is coupled to the first endpoint device, determine, based on the first network address included in the first packet, a second network interface, among the plurality of network interfaces, via which to transmit the first packet towards the destination of the first packet, and cause the first packet to be transmitted via the second network interface towards the destination of the first packet.

Embodiment 32: The cloud edge network device of embodiment 31, wherein the packet processor is configured to receive the first packet encapsulated with a tunneling header, wherein the tunneling header includes i) the second network address corresponding to the cloud edge network device and ii) the information identifying a first network interface, of the first network device in the underlay network, that is coupled to the first endpoint device.

Embodiment 33: The cloud edge network device of embodiment 32, wherein the packet processor is configured to receive the first packet encapsulated with a tunneling header based on virtual extensible local area network (VxLAN) protocol encapsulation.

Embodiment 34: The cloud edge network device of embodiment 32, wherein the packet processor is configured to receive the first packet encapsulated with a tunneling header based on segment routing (SR) over internet protocol encapsulation.

Embodiment 35: The cloud edge network device of any of the embodiments 31-34, wherein the first packet is a packet transmitted to the cloud edge network device located at a cloud edge data center in the cloud edge.

Embodiment 36: The cloud edge network device of any of the embodiments 31-35, wherein: the first packet further includes a third network address corresponding to the first endpoint device, and the packet processor is configured to, prior to transmitting the first packet, perform one or more of i) apply an access control list to the first packet based on the third network address included in the first packet, ii) apply a security access list to the first packet based on the third network address included in the first packet and iii) determine a virtual local area network (VLAN) to which the first packet belongs based on the third network address included in the first packet.

Embodiment 37: The cloud edge network device of any of the embodiments 31-36, wherein: the first packet further includes i) a third network address corresponding to the first endpoint device and ii) a fourth network address corresponding to the first network device in the underlay network, and the packet processor is further configured to populate an entry in a forwarding table to record an association between at least i) the third network address corresponding to the first endpoint device, ii) fourth network address corresponding to the first network device in the underlay network and iii) the information identifying the first network interface, of the first network device in the underlay network, that is coupled to the first endpoint device.

Embodiment 38: The cloud edge network device of any of the embodiments 31-37, wherein the packet processor is further configured to: receive a second packet, perform a lookup based on a destination network address included in the second packet to determine that the destination network address corresponds to the first endpoint device, encapsulate the second packet with a tunneling header, the tunneling header including i) the fourth network address corresponding to the first network device in the underlay network and ii) the information identifying first network interface, of the first network device in the underlay network, that is coupled to the first endpoint device, and cause the second packet to be transmitted, via the overlay network, to the first network device for subsequent transmission, via the first network interface of the first network device, to the first endpoint device.

Embodiment 39: The cloud edge network device of any of the embodiments 31-38, wherein the packet processor is configured to cause the second packet to be transmitted via a point-to-point link in the overlay network, the point-to-point link between the cloud edge network device in the cloud edge and the first endpoint device.

Embodiment 40: The cloud edge network device of any of the embodiments 31-39, wherein the packet processor is configured to cause the second packet to be transmitted via the overlay network, to the first network device for subsequent transmission, via the first network interface of the first network device, to one of i) a host computer coupled to the first network device and ii) a wireless resource unit coupled to the first network device.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory coupled to the processor, such as a RAM, a ROM, a flash memory, etc. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), etc.

While the present invention has been described with reference to specific examples, which are intended to be illustrative only and not to be limiting of the invention, changes, additions and/or deletions may be made to the disclosed embodiments without departing from the scope of the invention.

1. A method for transmitting packets in an underlay network that connects a plurality of endpoint devices to a cloud edge, the method comprising:
receiving a first packet via a first network interface of a first network device, the packet i) having been originated by a first endpoint device among the plurality of endpoint devices and ii) including a first network address indicating a destination of the first packet;
processing the first packet at the first network device, including, without analyzing the first network address in the first packet, adding, to the first packet, i) a second network address corresponding to a second network device, the second network device implemented at the cloud edge and ii) information identifying the first network interface via which the first packet was received by the first network device; and
transmitting, by the first network device via an overlay network layered over the underlay network, the first packet to the second network device in the cloud edge to enable forwarding of the first packet to the destination of the packet, based on the first network address included in the first packet, by the second network device.

2. The method of claim 1, wherein:
first network address is included in a first header of the first packet, and
processing the packet includes encapsulating the first packet with a second header, distinct from the first header, the second header including i) the second network address corresponding to a second network device, the second network device implemented at the cloud edge and ii) the information identifying the first network interface via which the first packet was received by the first network device.

3. The method of claim 2, wherein encapsulating the packet comprises encapsulating the packet based on virtual extensible local area network (VxLAN) protocol encapsulation.

4. The method of claim 2, wherein encapsulating the packet comprises encapsulating the packet based on segment routing (SR) over internet protocol encapsulation.

5. The method of claim 2, wherein
the first endpoint device is associated with an organization, and
adding information identifying the second network device comprises adding information identifying a first virtual network access device, among a plurality of virtual network access devices, implemented by the second network device in the cloud edge, the first network access device configured to perform forwarding of i) packets originated by endpoint devices associated with the organization and ii) packets directed to endpoint devices associated with the organization.

6. The method of claim 1, further comprising
performing, by the first network device, an authentication procedure with the second network device in the cloud edge to authenticate the first network device with a cloud provider in the cloud edge.

7. The method of claim 1, further comprising:
receiving a second packet via the second network interface of the network device, wherein the second packet i) is directed to the first endpoint device coupled to the access network and ii) includes information identifying the first user network interface of the first network device, and
processing the second packet with the packet processor of the network device, including determining, based on the information identifying the first user network interface of the first network device that the packet is to be transmitted via the first network interface of the first network device, and
transmitting the second packet via the first network interface to transmit the second packet to the first endpoint device.

8. The method of claim 1, wherein transmitting the first packet via the overlay network to the second network device in the cloud edge comprises transmitting the first packet via a point-to-point link in the overlay network, the point-to-point link connecting the first endpoint device to the second network device in the cloud edge.

9. The method of claim 1, wherein receiving the first packet comprises receiving the first packet from one of i) a host computer coupled to the first network device and ii) a wireless resource unit coupled to the first network device.

10. The method of claim 1, wherein transmitting the first packet over the overlay network to the second network device in the cloud edge comprises transmitting the first packet over the overlay network to a data center in the cloud edge.

11. A first network device in an underlay network that connects a plurality of endpoint devices to a cloud edge, the first network device comprising:
a plurality of network interfaces configured to receive packets via network links in an access network and to transmit packets via the network links in the access network, and
a packet processor coupled to the plurality of network interfaces, the packet processor configured to:
receive a first packet via a first network interface of a first network device, the packet i) having been originated by a first endpoint device among the plurality of endpoint devices and ii) including a first network address indicating a destination of the first packet;
process the packet at the first network device, including, without analyzing the first network address in the first packet, adding, to the first packet, i) a second network address corresponding to a second network device, the second network device implemented at the cloud edge and ii) information identifying the first network interface via which the first packet was received by the first network device; and
cause the packet to be transmitted via an overlay network layered over the underlay network, the first packet to the second network device in the cloud edge to enable forwarding of the first packet to the destination of the packet, based on the first network address included in the first packet, by the second network device.

12. The first network device of claim 11, wherein:
first network address is included in a first header of the first packet, and
the packet processor is configured to encapsulate the first packet with a second header, distinct from the first header, the second header including i) the second network address corresponding to a second network device, the second network device implemented at the cloud edge and ii) the information identifying the first network interface via which the first packet was received by the first network device.

13. The first network device of claim 12, wherein the packet processor is configured to encapsulate the first packet based on virtual extensible local area network (VxLAN) protocol encapsulation.

14. The first network device of claim 12, wherein the packet processor is configured to encapsulate the first packet based on segment routing (SR) over internet protocol encapsulation.

15. The first network device of claim 11, wherein
the first endpoint device is associated with an organization, and
the packet processor is configured to add, to the first packet, the information identifying the second network device at least by adding, to the first packet, information identifying a first virtual network access device, among a plurality of virtual network access devices, implemented by the second network device in the cloud edge, the first network access device configured to perform forwarding of i) packets originated by endpoint devices associated with the organization and ii) packets directed to endpoint devices associated with the organization.

16. The first network device of claim 11, wherein the packet processor is further configured to perform an authentication procedure with the second network device in the cloud edge to authenticate the first network device with a cloud provider in the cloud edge.

17. The first network device of claim 11, wherein the packet processor is further configured to
receive a second packet via the second network interface of the network device, wherein the second packet i) is directed to the first endpoint device coupled to the access network and ii) includes information identifying the first user network interface of the first network device,
process the second packet with the packet processor of the network device, including determining, based on the information identifying the first user network interface of the first network device that the packet is to be transmitted via the first network interface of the first network device, and
cause the second packet to be transmitted via the first network interface to transmit the second packet to the first endpoint device.

18. The first network device of claim 11, wherein the packet processor is configured to cause the first packet to be transmitted to the second network device via a point-to-point link in the overlay network, the point-to-point link connecting the first endpoint device to the second network device in the cloud edge.

19. The first network device of claim 11, wherein the packet processor is configured to receive the first packet from one of i) a host computer coupled to the first network device and ii) a wireless resource unit coupled to the first network device.

20. The first network device of claim 11, wherein the packet processor is configured to cause the first packet to be transmitted over the overlay network to a data center in the cloud edge.

21-40. (canceled)
